(19) United States
(12) Patent Application Publication
(10) Pub. No.: US 2024/0100847 A1
(43) Pub. Date: Mar. 28, 2024

(54) PRINTING-AGENT CONTAINER AND PRINTING-AGENT CONTAINER SET

(71) Applicant: BROTHER KOGYO KABUSHIKI KAISHA, Nagoya (JP)

(72) Inventors: Masahiro HAYASHI, Anjo (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 18/475,986

(22) Filed: Sep. 27, 2023

(30) Foreign Application Priority Data
Sep. 28, 2022 (JP) 2022-154348

(51) Int. Cl. B41J 2/175

(52) U.S. Cl. CPC B41J 2/17543; B41J 2/17553

(57) ABSTRACT

A printing-agent container, having a container body, an outflow port, and an identifying portion, is provided. The container body has a chamber for containing a printing agent. Through the outflow port, the printing agent flows out of the chamber. The identifying portion is provided to the container body correspondingly to a type of the printing agent contained in the chamber of the container body. The identifying portion has an inner surface defining the chamber.

### REFERENCE TO RELATED APPLICATIONS

This application claims priority from Japanese Patent Application No. 2022-154348 filed on Sep. 28, 2022. The entire content of the priority application is incorporated herein by reference.

### BACKGROUND ART

A single-color ink cartridge, in which an ink in a single color is packed, and a multi-color ink cartridge, in which inks in multiple colors of magenta, cyan, yellow, and black are packed, are known. An operator of an apparatus may visually recognize which one of the ink cartridges is mounted in a cartridge case in the apparatus through a transparent window in the apparatus. Through the transparent window, the operator may recognize whether the ink cartridge is located at a correct position in the apparatus, and thereby the apparatus may be restrained from operating with the cartridge located at an incorrect position.

### DESCRIPTION

After the ink is consumed, the cartridge may be reused. For being reused, the cartridge may be disassembled into parts, and some of the parts that were exposed to the ink may be cleansed. However, even after the cleansing, some components of the ink may remain in the parts and react with components in refilling ink when the cartridge is reloaded. Therefore, it may be preferable that a type of the ink contained in the cleansed parts is visually identifiable to the operator.

The present disclosure is advantageous in that a container, in which a type of a printing agent contained earlier in a chamber of the container is easily identifiable based on a feature of a part of the container that defines the chamber, is provided.

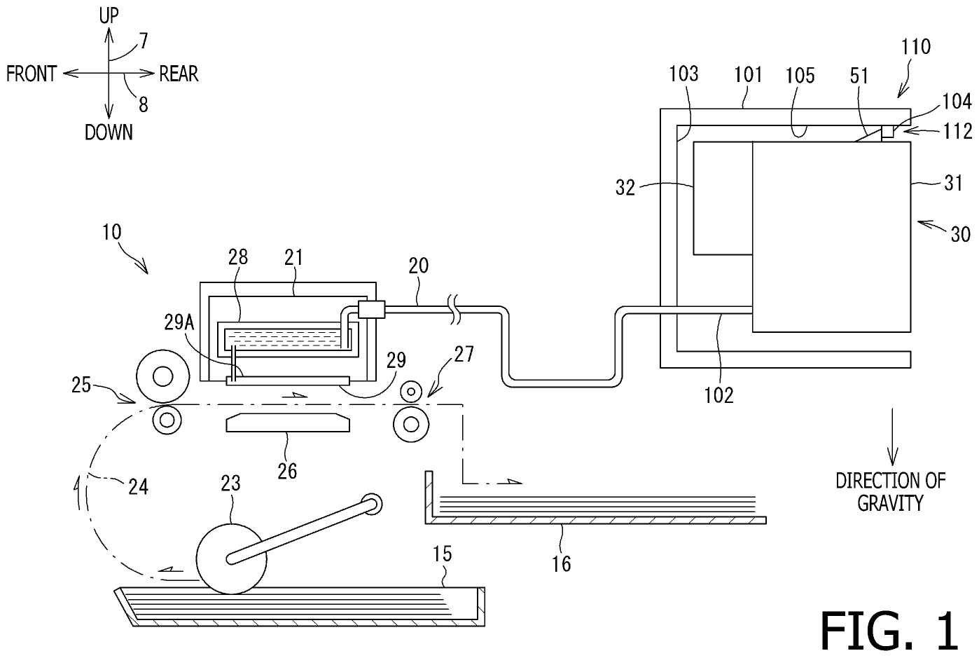

FIG. 1 is a schematic cross-sectional view of an internal structure of a printer 10.

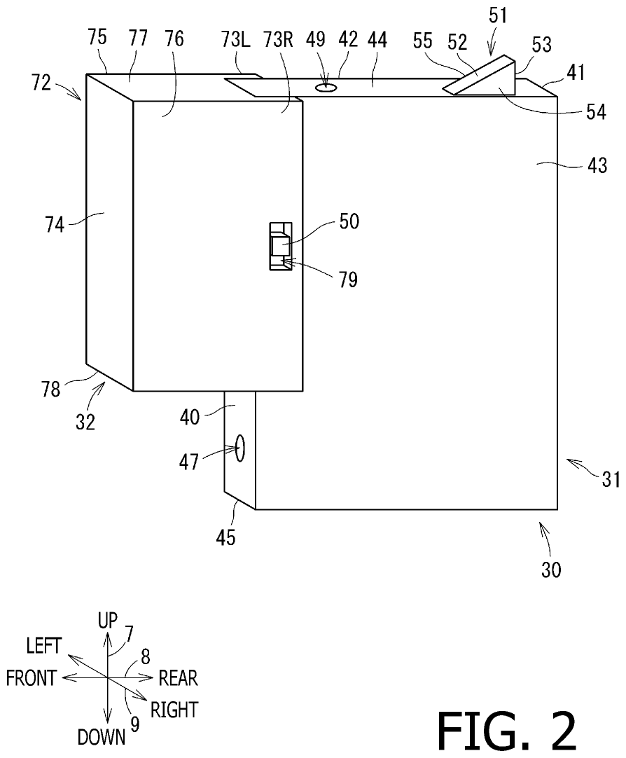

FIG. 2 is a perspective view of an ink cartridge 30.

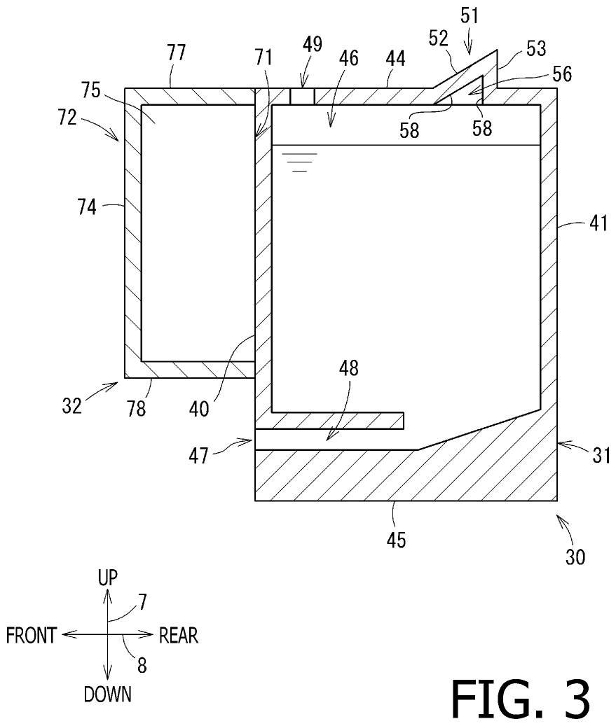

FIG. 3 is a cross-sectional view of the ink cartridge 30.

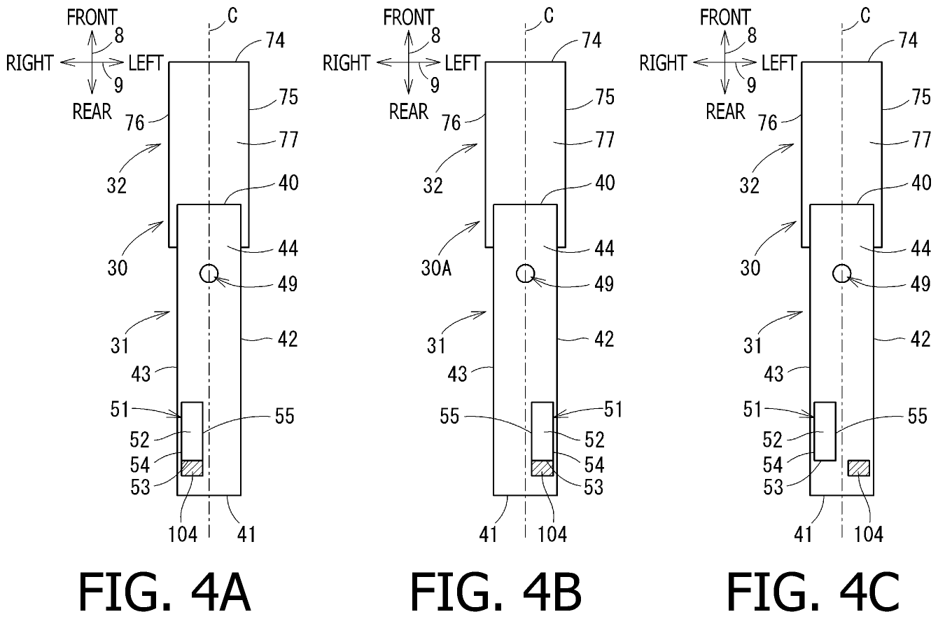

FIGS. 4A-4C are plan views of locking members 104 and a cartridge set including the ink cartridge 30 and an ink cartridge 30A.

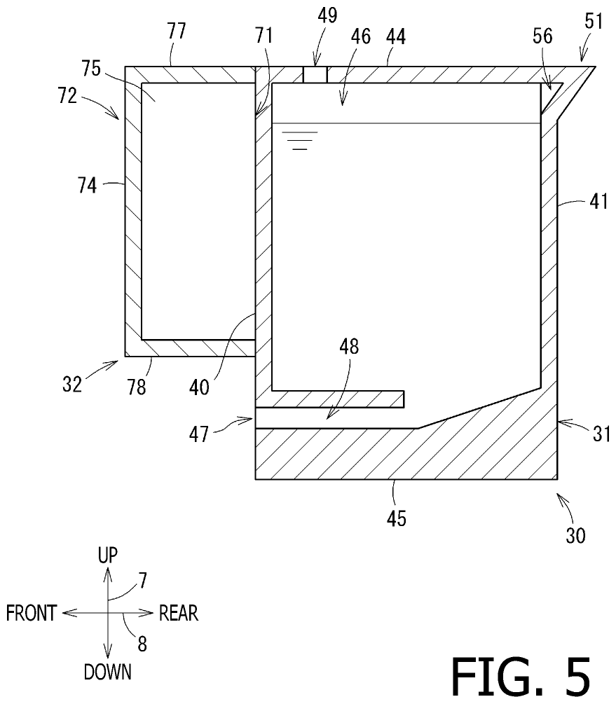

FIG. 5 is a schematic cross-sectional view of another ink cartridge 30.

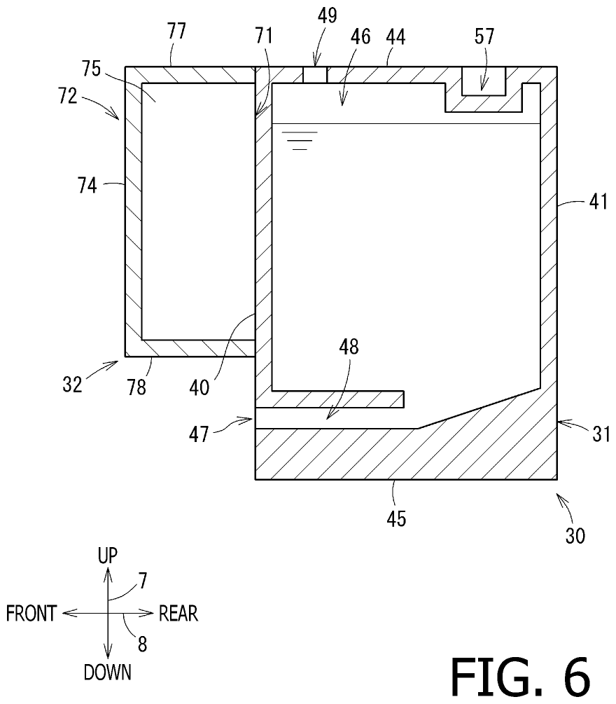

FIG. 6 is a cross-sectional view of another ink cartridge 30.

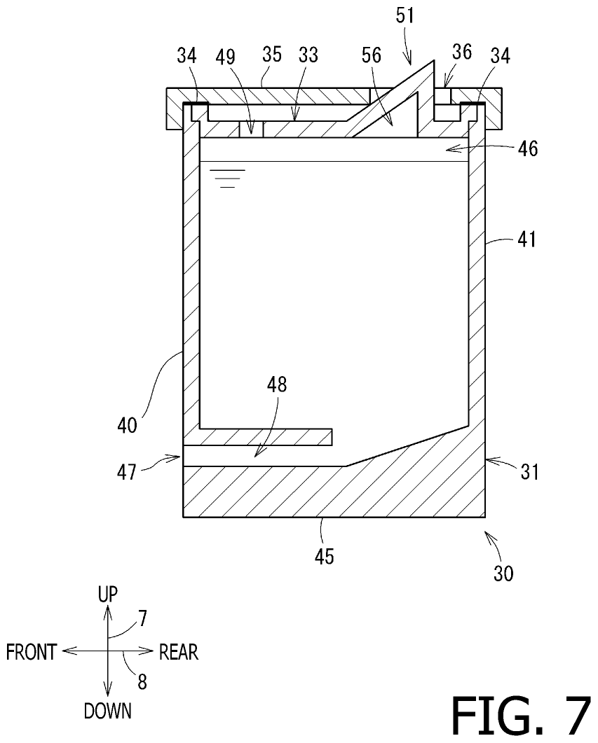

FIG. 7 is a cross-sectional view of another ink cartridge 30.

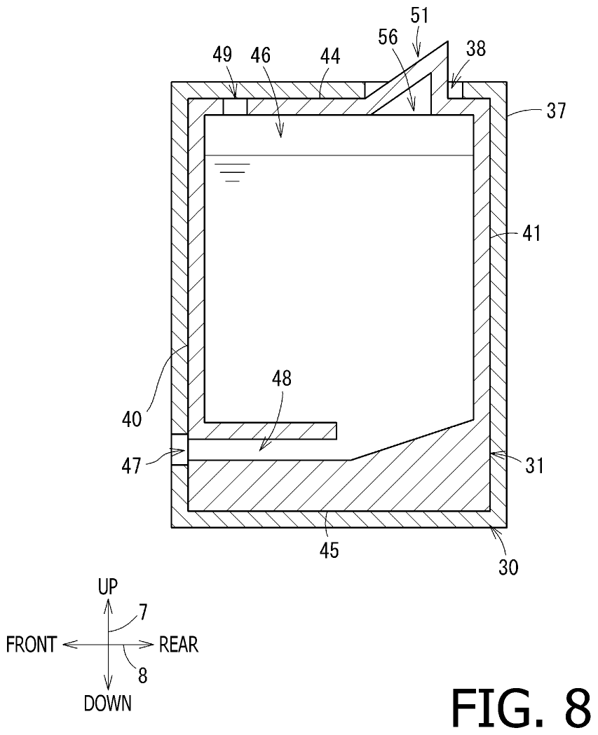

FIG. 8 is a cross-sectional view of another ink cartridge 30.

In the following paragraphs, embodiments of the present disclosure will be described with reference to the accompanying drawings. It is noted that an ink cartridge 30 described below is merely an exemplary embodiment of the present disclosure, and various connections may be set forth between elements in the following description. These connections in general and, unless specified otherwise, may be direct or indirect and that this specification is not intended to be limiting in this respect.

In the following paragraphs, the ink cartridge 30 is movable to be mounted in and demounted from a cartridge case 110 along a horizontal direction, i.e., a direction intersecting orthogonally with the direction of gravity. Further, whenever appropriate, a frontward direction and a rearward direction may be collectively referred to as a front-rear direction 8. An upward direction and a downward direction may be collectively referred to as an up-down direction 7. A rightward direction and a leftward direction may be collectively referred to as a right-left direction 9. Therefore, the front-rear direction 8 and the right-left direction 9 may be understood as the horizontal direction. Meanwhile, the up-down direction 7 may be defined as directions vertically intersecting with the front-rear direction 8. Moreover, in the following paragraphs, a state where the ink cartridge 30 is mounted in the cartridge case 110 and usable, may be equal to a state, in which the ink cartridge 30 inserted in the cartridge case 110 is located at a mounted position. The mounted position is a position, at which an ink needle 102 located in the cartridge case 110 is coupled with an outflow port 47 of the ink cartridge 30. In the following paragraphs, further, a mounted position of the ink cartridge 30, in the state where the ink cartridge 30 is mounted in the cartridge case 110 and usable, may also be called a usable position.

In the following paragraphs, furthermore, a term “frontward” may mean a direction, in which the ink cartridge 30 is inserted into the cartridge case 110 along the front-rear direction 8, and the frontward direction in the present embodiment is an example of mounting direction. A term “rearward” may mean a direction, in which the ink cartridge 30 is removed from the cartridge case 110 along the front-rear direction 8. An expression “face frontward” may mean facing in a direction, which includes a frontward component, and an expression “face rearward” may mean facing in a direction, which includes a rearward component. An expression “face downward” may mean facing a direction, which includes a downward component, and an expression “face upward” may mean facing a direction, which includes an upward component. For example, a phrase “a front surface faces frontward” may mean not only that the front surface faces frontward but also that the front surface faces toward a side in a direction slanting with resect the frontward direction.

Overall Configuration of Printer 10

As shown in FIG. 1, a printer 10 is an image forming apparatus in an inkjet recording method, which may record images on a sheet by discharging ink droplets at the sheet, and may be, for example, an inkjet printer. The printer 10 has the cartridge case 110, which is an example of case. In the cartridge case 110, the ink cartridge 30 being an example of printing-agent container is mountable. The cartridge case 110 has an opening 112, which is located on one side of the cartridge case 110. The ink cartridge 30 may be inserted frontward through the opening 112 into the cartridge case 110 and pulled rearward through the opening 112 to be removed from the cartridge case 110. FIG. 1 shows the ink cartridge 30 completely mounted in the cartridge case 110. In other words, the ink cartridge 30 in FIG. 1 is in a mounted state. The position of the ink cartridge 30 in the mounted state is the usable position.

The ink cartridge 30 may store liquid being an example of printing agent. For example, the ink cartridge 30 may store a printing agent, e.g., ink, to be used in the printer 10. In the state where the ink cartridge 30 is completely mounted in the cartridge case 110, the ink cartridge 30 and a recording head 21 are connected through an ink tube 20. The recording head 21 may discharge the ink supplied from the ink cartridge 30 through a plurality of nozzles 29. In particular, driving voltages may be applied by a head-controlling board (not shown) in the recording head 21 selectively to a plurality of piezoelectric devices 29A, which are arranged in one-to-one correspondence with the plurality of nozzles 29. Thereby, the ink droplets may be discharged selectively through the nozzles 29. Thus, the recording head 21 may consume the ink contained in the ink cartridge 30, which is mounted in the cartridge case 110.

The printer 10 has a feeder tray 15, a feeder roller 23, a conveyer roller pair 25, a platen 26, an ejection roller pair 27, and an ejection tray 16. The feeder roller 23 may feed a sheet on the feeder tray 15 to a conveyer path 24. The sheet fed to the conveyer path 24 may reach the conveyer roller pair 25. The conveyer roller pair 25 may convey the sheet reaching the conveyer roller pair 25 to an upper side of the platen 26. The recording head 21 may discharge the ink selectively at the sheet being conveyed to the platen 26. Thereby, an image may be recorded on the sheet. The sheet passing over the platen 26 may reach the ejection roller pair 27. The ejection roller pair 27 may eject the sheet reaching the ejection roller pair 27 at the ejection tray 16, which is located at a most downstream position in the conveyer path 24.

Cartridge Case 110

As shown in FIG. 1, the cartridge case 110 has a case 101, the ink needle 102, and a locking member 104 being an example of engagement portion. The cartridge case 110 may accommodate the ink cartridge 30.

As shown in FIG. 1, the case 101 has a shape of a box.

The ink needle 102 is in a tubular shape and is located at a lower position in an end surface 103 of the case 101. The ink needle 102 is located at a position corresponding to the outflow port 47 (see FIG. 2) of the ink cartridge 30 mounted in the cartridge case 110. The ink needle 102 protrudes from the end surface 103 of the case 101 along the front-rear direction 8, and a tip of the ink needle 102 is open rearward. The tip of the ink needle 102 have either a plane or pointy shape.

The locking member 104 protrudes downward from a ceiling 105 of the case 101 at a position in vicinity of the opening 112. The locking member 104 is located at a position corresponding to an identifying portion 51 in the ink cartridge 30 inserted in the cartridge case 110. While the ink cartridge 30 is mounted in the cartridge case 110, the locking member 104 may contact a rearward surface of the identifying portion 51. With the locking member 104 contacting the identifying portion 51 from the rear side, the ink cartridge 30 may stay mounted in the cartridge case 110 without moving rearward.

Ink Cartridge 30

The ink cartridge 30 is a container to store liquid, e.g., the ink. As shown in FIG. 2, the ink cartridge 30 has a container body 31 and a cover 32.

As shown in FIG. 2, the container body 31 has a thin parallelepiped shape, of which dimension in the right-left direction 9 is smaller than dimensions thereof in the up-down direction 7 and in the front-rear direction 8.

The container body 31 has a front wall 40, a rear wall 41 facing the front wall 40 in the front-rear direction 8, a leftward wall 42 continuous with the front wall 40 and the rear wall 41, a rightward wall 43 facing the leftward wall 42 in the right-left direction 9, an upper wall 44 continuous with the front wall 40 and the rear wall 41, and a lower wall 45 facing the upper wall 44 in the up-down direction 7. The leftward wall 42 is an example of first side wall, and the rightward wall 43 is an example of second side wall. An outer surface of the front wall 40 faces frontward. An outer surface of the rear wall 41 faces rearward. An outer surface of the leftward wall 42 faces leftward. An outer surface of the rightward wall 43 faces rightward. An outer surface of the upper wall 44 faces upward. An outer surface of the lower wall 45 faces downward.

The front wall 40, the rear wall 41, the leftward wall 42, the rightward wall 43, the upper wall 44, and the lower wall 45 define a chamber 46 in a space inside the container body 31. The chamber 46 is located between the front wall 40 and the rear wall 41. The front wall 40, the rear wall 41, the leftward wall 42, the rightward wall 43, the upper wall 44, and the lower wall 45 are substantially translucent allowing the user to visually recognize a liquid surface of the ink contained in the chamber 46 from outside. The container body 31 may be formed integrally. The container body 31 is made of resin, for example, synthetic resin.

The outflow port 47 is positioned at a lower portion of the front wall 40. In the present embodiment, the outflow port 47 is open externally. Optionally, the outflow port 47 may be closable with a closing device such as a valve. The outflow port 47 is open frontward. In other words, the supply port 47 is open in the front-rear direction 8.

As shown in FIG. 3, inside the container body 31, an ink flow path 48 extends from the outflow port 47 along the front-rear direction 8. The ink flow path 48 is continuous with the outflow port 47 and a lower end of the chamber 46. In other words, a frontward end of the ink flow path 48 defines the outflow port 47. The ink contained in the chamber 46 may flow outward through the ink flow path 48 and from the outflow port 47.

The upper wall 44 includes an air release path 49. The air release path 49 connects an upper end of the chamber 46 to the outside of the chamber 46. Through the air release path 49, the air may be exchanged between the outside and the inside of the chamber 46. Through the air release path 49, air pressure of an air layer in the chamber 46 is equated with the atmospheric pressure. An opening of the air release path 49 on the outer surface of the upper wall 44 is open upward. Optionally, the air release path 49 may be closable with, for example, a valve, a semi-translucent film, etc.

As shown in FIG. 2, in a frontward end area on the rightward wall 43, a protrusion 50 protrudes rightward from the outer surface of the rightward wall 43. Although not shown in the drawings, a protrusion 50 protrudes leftward from the outer surface of the leftward wall 42 in a frontward end area on the leftward wall 42.

As shown in FIGS. 2 and 3, the identifying portion 51 is located on the outer surface of the upper wall 44. The identifying portion 51 is located rearward with respect to the air release path 49. The identifying portion 51 protrudes upward from the outer surface of the upper wall 44. The identifying portion 51 has a slant surface 52, a locking surface 53 facing rearward, a rightward surface 54 facing rightward, and a leftward surface 55 facing leftward. The slant surface 52 is slanted with respect to the front-rear direction such that the slant surface 52 extends upward from a front end toward a rear end of the identifying portion 51. The slant surface 52 is rectangular shape. The locking surface 53 is rectangular shape. The rightward surface 54 and the leftward surface 55 are triangular shapes.

The identifying portion 51 is formed integrally with the container body 31. The identifying portion 51 includes inner surfaces 58. Inner surfaces 58 of the identifying portion 51 define an inner space 56 inside the container body 31. The inner space 56 is a space open downward and is continuous with the chamber 46 at the downward end thereof. An upper end of the inner space 56 is located above the upper wall 44 in the mounted position.

The identifying portion 51 is located at a different position in the right-left direction 9 on the upper wall 44 according to, for example, a type of the ink contained in the chamber 46. The type of the ink may be, for example, a color of the ink, composition of the ink, etc. In other words, the identifying portion 51 is located in a particular position on the upper wall 44 corresponding to a type of the printing agent contained in the chamber 46 of the container body 31. The ink cartridge 30 shown in FIG. 2 is located at a position rightward from a center C (see FIGS. 4A-4C) of the upper wall 44 in the right-left direction 9. Thus, the identifying portion 51 of the ink cartridge 30 is located closer to one side, e.g., a rightward side, of the upper wall 44 than to the other side, e.g., a leftward side, of the upper wall 44. As shown in FIG. 4A, the locking member 104 of the case 101 is located at a position corresponding to the identifying portion 51. Therefore, when the ink cartridge 30 is inserted in the case 101, the slant surface 52 of the identifying portion 51 may slide against the locking member 104, and a rearward part of the ink cartridge 30 may shift downward as the ink cartridge 30 proceeds frontward. When the slant surface 52 reaches a position frontward with respect to the locking member 104, the rearward part of the ink cartridge 30 may shift upward. When the locking surface 53 of the identifying portion 51 and the locking member 104 face each other in the front-rear direction 8, the locking surface 53 may contact the locking member 104. Thus, the identifying portion 51 and the locking member 104 are engaged, and the ink cartridge 30 may be maintained in the mounted state.

For example, an ink cartridge 30A, which is different from the ink cartridge 30 in the type of the ink contained therein, has the identifying portion 51 located at a position leftward from the center C of the upper wall 44 in the right-left direction 9. Thus, the identifying portion 51 of the ink cartridge 30A is located closer to the other side, e.g., the leftward side, of the upper wall 44 than to the one side, e.g., the rightward side, of the upper wall 44. A case 101A (not shown), in which the ink cartridge 30A may be mounted, has the locking member 104 at a position to correspond to the identifying portion 51 at the leftward position. Therefore, when the ink cartridge 30A is inserted in the case 101A, the locking surface 53 of the identifying portion 51 and the locking member 104 may face each other in the front-rear direction 8. Therefore, the identifying portion 51 engages with the locking member 104, and the ink cartridge 30A may be maintained in the mounted state.

For example, if the ink cartridge 30 with the identifying portion 51 located at the rightward position is inserted in the case 101A (not shown) having the locking member 104 shown in FIG. 4B, the identifying portion 51 may not face the locking member 104 in the front-rear direction 8, as shown in FIG. 4C. Therefore, when the ink cartridge 30 is inserted in the case 101A with the locking member 104 shown in FIG. 4B, the identifying portion 51 may not engage with the locking member 104. Accordingly, the ink cartridge 30 may not be maintained in the mounted condition.

The cover 32 being an example of cover member has a shape of a parallelepiped smaller than the container body 31 and has an opening 71 which is open rearward. The cover 32 is attached to the container body 31 to cover a part of the front wall 40 of the container body 31 higher than the outflow port 47.

The cover 32 has a covering body 72 and extended parts 73L, 73R. The covering body 72 is in a shape of a box having the opening 71 which is open rearward. The covering body 72 has a leftward wall 75 and a rightward wall 76 having the opening 71. The extended parts 73L, 73R extend from a rear end of the leftward wall 75 and a rear end of the rightward wall 76, respectively.

The covering body 72 has a front wall 74, a leftward wall 75 extending rearward from a leftward end of the front wall 74, a rightward wall 76 facing the leftward wall 75 in the right-left direction 9, an upper wall 77 extending rearward from an upper end of the front wall 74, and a lower wall 78 facing the upper wall 77 in the up-down direction 7. An outer surface of the front wall 74 faces frontward. An outer surface of the leftward wall 75 faces leftward. An outer surface of the rightward wall 76 faces rightward. An outer surface of the upper wall 77 faces upward. An outer surface of the lower wall 78 faces downward. The front wall 74, the leftward wall 75, the upper wall 77, and the lower wall 78 define an inner space inside the covering body 72.

A dimension of the covering body 72 along the up-down direction 7 is smaller than a dimension of the container body 31 along the up-down direction 7. A dimension of the covering body 72 along the front-rear direction 8 is smaller than a dimension of the container body 31 along the front-rear direction 8. A dimension of the covering body 72 along the right-left direction 9 is substantially larger than a dimension of the container body 31 along the right-left direction 9.

The extended part 73R extends rearward from the rear end of the rightward wall 76. The extended part 73R has a shape of a plate. In a vertically central area in the extended part 73R, a through hole 79 is formed through in the right-left direction 9. In the through hole 79, the protrusion 50 is inserted. The through hole 79 has a rectangular shape, of which dimensions are greater than external dimensions of the protrusion 50. A dimension of the through hole 79 along the up-down direction 7 is greater than a dimension of the through hole 79 along the front-rear direction 8. The dimension of the through hole 79 in the up-down direction 7 is substantially greater than a dimension of the protrusion 50 along the up-down direction 7. Therefore, the protrusion 50 inserted in the through hole 79 is movable in the up-down direction 7. Although not shown in the drawings, the leftward wall 75 has a through hole 79, which is in the same shape as the through hole 79 on the rightward wall 76.

The leftward wall 75 and the rightward wall 76 face each other in the right-left direction 9. Between the leftward wall 75 and the rightward wall 76, the container body 31 is inserted. With the protrusion 50 located on the leftward wall 75 of the container body 31 being inserted in the through hole 79 in the extended part 73L, and the protrusion 50 located on the rightward wall 76 of the container body 31 being inserted in the through hole 79 in the extended part 73R, the cover 32 may be attached to the container body 31. The cover 32 is, in the state where the cover 32 is attached to the container body 31, movable in the up-down direction 7 with respect to the container body 31 within the range, in which the protrusions 50 are movable in the up-down direction 7 in the through holes 79.

The cover 32, in the state where the cover 32 is attached to the container body 31, covers a part of the front wall 40, including an upper part of the front wall 40, of the container body 31. The outer surface of the front wall 74 of the cover 32, which is an example of front surface, is located frontward with respect to the outflow port 47. The outflow port 47 is located at a position lower than a lower end of the opening 71 in the cover 32.

Benefits

According to the ink cartridge 30 described above, the position of the identifying portion 51 in the right-left direction 9 on the upper wall 44 may be visually recognizable; therefore, the type of the ink stored in the chamber 46 in the container body 31 may be identified. Moreover, after the ink stored in the chamber 46 is consumed, in a state where substantially no ink remains in the chamber 46, the type of the ink having been stored in the past in the chamber 46 in the container body 31 may be identified.

Moreover, the inner space 56 inside the identifying portion 51 is located to be higher than the upper wall 44 of the container body 31 in the ink cartridge 30 in the mounted position. Therefore, the inner space 56 may not be exposed to the ink or retain the ink easily.

Moreover, the part of the front wall 40 of the container body 31 is covered by the cover 32. Therefore, the outflow port 47 located in the front wall 40 may be protected from colliding with external parts.

Moreover, the container body 13 is formed of synthetic resin in one piece. Therefore, the container body 31 may be formed in blow-molding.

Moreover, the identifying portion 51 is engageable with the locking member 104 in the cartridge case 110. Therefore, as shown in FIG. 4C, if the identifying portion 51 and the locking member 104 are in different positions in the right-left direction 9 when the user attempts to insert the ink cartridge 30 into the cartridge case 110, the identifying portion 51 may not engage with the locking member 104. On the other hand, if the identifying portion 51 engages with the locking member 104, the user may immediately recognize that the ink cartridge 30 is mounted at the correct position in the cartridge case 110. Moreover, in the state where the identifying portion 51 and the locking member 104 are engaged, the locking surface 53 of the identifying portion 51 contacts the locking member 104. Thus, the identifying portion 51 may not only serve as a physical key to engage with the locking member 104 but also lock the ink cartridge 30 to stay in the cartridge case 110 without falling rearward.

While the disclosure has been described in conjunction with various example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the disclosure, and not limiting the disclosure. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described disclosure are provided below.

### Modified Examples

For example, the inner space 56 in the identifying portion 51 may not necessarily be located to be higher than the upper wall 44 of the container body 31 in the ink cartridge 30 in the mounted position. As shown in FIG. 5, the inner space 56 may be located on the rear wall 41 at a position higher than a level of a liquid surface of the ink primarily packed in the chamber 46. In the arrangement where the identifying portion 51 is located on the rear wall 41, the identifying portion 51 may not necessarily function as the physical key or function to lock the ink cartridge 30 to the cartridge case 110. Moreover, optionally, the identifying portion 51 may be located on the leftward wall 42 or the rightward wall 43 rather than the rear wall 41. Moreover, the inner space 56 in the identifying portion 51 may be located at a position higher than the outflow port 47 or higher than a bottom of the chamber 46.

For another example, the identifying portion 51 may not necessarily protrude upward from the upper wall 44. In place, as shown in FIG. 6, an identifier 57 recessed downward from the upper wall 44 may be provided. For another example, the identifier 57 may be located on the rear wall 41, the leftward wall 42, or the rightward wall 43.

For another example, the container body 31 may not necessarily be formed in one piece integrally but may be composed of a plurality of parts made of synthetic resin. For example, as shown in FIG. 7, the container body 31 may not necessarily have the upper wall 44 but may have an opening on the upper side. The opening may be covered by an inner lid 33 and may be sealed by a film 34. In this arrangement, the cover 32 may not be provided. Further, an upper cover 35 may be fitted on the container body 31 so that an upper side of the inner lid 33 may be covered by the upper cover 35. In this arrangement, the identifying portion 51 may be located in the inner lid 33 and may be exposed outward through a through hole 36 in the upper cover 35. Moreover, the air release path 49 may be located in the inner lid 33.

For another example, as shown in FIG. 8, the ink cartridge 30 may have a cover 37 that may enclose the container body 31 entirely in place of the cover 32. In this arrangement, the identifying portion 51 may be exposed outward through a through hole 38 in the cover 37.

For another example, the ink cartridge 30 may not necessarily have the cover 32. For another example, the identifying portion 51 may not necessarily be located at different positions only in the right-left direction 9 but may be located at different positions also in the up-down direction 7 and/or the front-rear direction 8, and/or an exterior shape of the identifying portion 51 may be varied depending on the type of the ink to be contained in the ink cartridge 30.

For another example, the air release path 49 may not necessarily be located in the upper wall 44 but may be located in the front wall 40. In this arrangement, the opening of the air release path 49 on the outer surface of the front wall 40 is open frontward. Optionally, the opening of the air release path 49 may be covered by the cover 32.

For another example, the outflow port 47 may not necessarily be located in the front wall 40 of the container body 31, but the ink cartridge 30 may have a supplying portion, which protrudes frontward from the front wall 40, and an ink flow path 48 may be located inside the supplying portion. The outflow port 47 may be located at a tip of the supplying portion.

For another example, the exterior shapes of the container body 31 and the cover 32 may not necessarily be limited to the parallelepiped or boxed shapes. For example, the container body 31 may have a protrusion, and the like, through which the user may handle the ink cartridge 30. For another example, the chamber 46 may have a detecting device that may detect the ink in the chamber 46. Similarly, the cover 32 may have a protrusion, and the like, through which the operator may handle the cover 32.

For another example, the cover 32 may not necessarily be attached to the container body 31 by the protrusions 50 being inserted in the through holes 79 in the cover 32, but the structure to attach the cover 32 to the container body 31 may be replaced with another attachable structure.

For another example, the printing agent to be stored in the container body 31 may not necessarily be limited to the ink. A recording agent other than the ink, such as a preprocessing liquid to be applied to the sheet before the ink is discharged at the sheet, toner, and the like, may be contained in the container body 31.

For another example, the container to contain the printing agent may not necessarily be limited to the ink cartridge 30 to be mounted in the printer 10 but may be, for example, a bottle to contain the printing agent to refill a tank in the printer.

For another example, the printer 10 may be operable with an ink cartridge set, which includes a plurality of ink cartridges 30, 30A mountable in the cartridge case 110. In other words, a plurality of ink cartridges 30, 30A, each of which contains ink in a different color, may be mounted in the cartridge case 110 and connected to the recording head 21 through a plurality of ink tubes 20, and the printer 10 may record a multicolored image on a sheet. In this arrangement, the identifying portions 51 of the ink cartridges 30, 30A may be located at different positions in the right-left direction 9 from one another on the upper walls 44 depending on the colors of the respective inks contained therein. In this arrangement, the operator working to mount the ink cartridges 30, 30A in the cartridge case 110 may recognize that the mounted positions in the cartridge case 110 for the ink cartridges 30, 30A are correct or incorrect immediately.

What is claimed is:

1. A printing-agent container, comprising:
a container body having a chamber for containing a printing agent;
an outflow port for the printing agent to flow out of the chamber there-through; and
an identifying portion provided to the container body correspondingly to a type of the printing agent contained in the chamber of the container body,
wherein the identifying portion has an inner surface defining the chamber.

2. The printing-agent container according to claim 1, wherein the identifying portion has a shape corresponding to the type of the printing agent contained in the chamber of the container body.

3. The printing-agent container according to claim 1, wherein the identifying portion is located in a position on the container body corresponding to the type of the printing agent contained in the chamber of the container body.

4. The printing-agent container according to claim 1, wherein
the printing-agent container is configured to be mounted in a case of an image recording apparatus to supply the printing agent to a head of the image recording apparatus, and
the inner surface of the identifying surface is located above a bottom of the chamber in a state where the printing-agent container is mounted in a mounted position in the case.

5. The printing-agent container according to claim 1, wherein
the printing-agent container is configured to be mounted in a case of an image recording apparatus and to supply the printing agent to a head of the image recording apparatus, and
the inner surface of the identifying portion is located above the outflow port in a state where the printing-agent container is mounted in a mounted position in the case.

6. The printing-agent container according to claim 1, wherein
the printing-agent container is configured to be mounted in a case of an image recording apparatus to supply the printing agent to a head of the image recording apparatus, and
the inner surface of the identifying portion is located above a level of a liquid surface of the printing agent primarily packed in the chamber in a state where the printing-agent container is mounted in a mounted position in the case.

7. The printing-agent container according to claim 1, wherein
the printing-agent container is configured to be mounted in a case of an image recording apparatus to supply the printing agent to a head of the image recording apparatus,
the identifying portion protrudes from an outer surface of the container body, and
the inner surface of the identifying portion is located above the outer surface of the container body in a state where the printing-agent container is mounted in a mounted position in the case.

8. The printing-agent container according to claim 7, wherein the outflow port is located in a front face of the container body in a mounting direction in which the printing-agent container is mounted in the case.

9. The printing-agent container according to claim 8, further comprising a cover member configured to cover at least a part of the front face of the container body.

10. The printing-agent container according to claim 1, wherein the container body is formed of synthetic resin integrally.

11. The printing-agent container according to claim 1, wherein
the printing-agent container is configured to be mounted in a case of an image recording apparatus to supply the printing agent to a head of the image recording apparatus, and
the identifying portion is engageable with an engagement portion in the case in a state where the printing-agent container is mounted in a mounted position in the case.

12. The printing-agent container according to claim 11, wherein the identifying portion has a surface facing opposite to a mounting direction in which the printing-agent container is mounted in the case such that the surface is in contact with the engagement portion in the state where the printing-agent container is mounted in the mounted position in the case.

13. The printing-agent container according to claim 1, further comprising an upper cover covering an upper surface of the container body,
wherein the identifying portion is located on the upper surface and is exposed externally through a through hole in the upper cover.

14. The printing-agent container according to claim 1, further comprising a cover covering the container body,
wherein the identifying portion is exposed externally through a through hole in the cover.

15. A printing-agent container set including a first container and a second container, the first container and the second container being configured to be attached to a case of an image recording apparatus, wherein
the first container includes:
a first container body having a first chamber for containing a printing agent, and a first outer surface located above the first chamber in a height direction;
a first outflow port for the printing agent to flow out of the first chamber there-through, the first outflow port being open in a frontward direction when the first container is attached to the case, the frontward direction being perpendicular to the height direction; and
a first protrusion provided to the first outer surface of the first container body, the first protrusion having a first inner surface defining the first chamber, and
the second container includes:
a second container body having a second chamber for containing a printing agent different from the printing agent contained in the first chamber of the first container body, and a second outer surface located above the second chamber in the height direction;
a second outflow port for the printing agent to flow out of the second chamber there-through, the second outflow port being open in the frontward direction when the second container is attached to the case; and
a second protrusion provided to the second outer surface of the second container body, the second protrusion having a second inner surface defining the second chamber,
each of the first outer surface of the first container and the second outer surface of the second container has a first side to be located closer to one side of the case than to the other side of the case in a width direction and a second side to be located closer to the other side of the case than to the one side of the case in the width direction when the first container and the second container are attached to the case, the width direction being perpendicular to the frontward direction and the height direction,
the first protrusion of the first container is located closer to the first side of the first outer surface of the first container than to the second side of the first outer surface of the first container in the width direction, and
the second protrusion of the second container is located closer to the second side of the second outer surface of the second container than to the first side of the second outer surface of the second container in the width direction.

16. The printing-agent container set according to claim 15, wherein
the first container is configured to be mounted in the case of the image recording apparatus to supply the printing agent to a head of the image recording apparatus, and
the first inner surface of the first protrusion is located above a bottom of the first chamber in a state where the first container is mounted in a mounted position for the first container in the case, and
the second container is configured to be mounted in the case of the image recording apparatus to supply the printing agent to the head of the image recording apparatus, and
the second inner surface of the second protrusion is located above a bottom of the second chamber in a state where the second container is mounted in a mounted position for the second container in the case.

17. The printing-agent container set according to claim 15, wherein
the first container is configured to be mounted in the case of the image recording apparatus and to supply the printing agent to a head of the image recording apparatus, and
the first inner surface of the first protrusion is located above the first outflow port in a state where the first container is mounted in a mounted position for the first container in the case, and
the second container is configured to be mounted in the case of the image recording apparatus and to supply the printing agent to the head of the image recording apparatus, and
the second inner surface of the second protrusion is located above the second outflow port in a state where the second container is mounted in a mounted position for the second container in the case.

18. The printing-agent container set according to claim 15, wherein
the first container is configured to be mounted in the case of the image recording apparatus to supply the printing agent to a head of the image recording apparatus, and
the first inner surface of the first protrusion is located above a level of a liquid surface of the printing agent primarily packed in the first chamber in a state where the first container is mounted in a mounted position for the first container in the case,
the second container is configured to be mounted in the case of the image recording apparatus and to supply the printing agent to the head of the image recording apparatus, and
the second inner surface of the second protrusion is located above a level of a liquid surface of the printing agent primarily packed in the second chamber in a state where the second container is mounted in a mounted position for the second container in the case.

19. The printing-agent container set according to claim 15, wherein
the first container is configured to be mounted in the case of the image recording apparatus to supply the printing agent to a head of the image recording apparatus,
the first protrusion protrudes from the first outer surface of the first container body,
the first inner surface of the first protrusion is located above the first outer surface of the first container body in a state where the first container is mounted in a mounted position for the first container in the case, and
the second container is configured to be mounted in the case of the image recording apparatus to supply the printing agent to the head of the image recording apparatus,
the second protrusion protrudes from the second outer surface of the second container body, and
the second inner surface of the second protrusion is located above the second outer surface of the second container body in a state where the second container is mounted in a mounted position for the second container in the case.
